(19) United States
(12) Patent Application Publication
(10) Pub. No.: US 2026/0065148 A1
(43) Pub. Date: Mar. 5, 2026

(54) A COMPUTER IMPLEMENTED METHOD, AND A SERVER

(71) Applicant: GRABTAXI HOLDINGS PTE. LTD., Singapore (SG)

(72) Inventors: Wenmiao HU, Singapore (SG); Yichen ZHANG, Singapore (SG); Roger ZIMMERMANN, Singapore (SG); Andrei GEORGESCU, Cluj County (RO); Lam An TRAN, Singapore (SG); Hannes Martin KRUPPA, Singapore (SG)

(21) Appl. No.: 19/107,260

(22) PCT Filed: Aug. 23, 2023
(86) PCT No.: PCT/SG2023/050580

§ 371 Date: Feb. 27, 2025

(30) Foreign Application Priority Data
Sep. 26, 2022 (SG) 10202251145Y

(51) Int. Cl. G06N 20/00; G06T 3/60; G06T 5/10; G06V 10/74; G06V 10/77

(52) U.S. Cl. CPC G06N 20/00; G06T 3/60; G06T 5/10; G06V 10/761; G06V 10/7715; G06T 2207/20132

(57) ABSTRACT

A computer assisted method comprising: storing a training dataset including a plurality of geotagged candidate images and a plurality of query images, each query image having at least one corresponding candidate image having the same geolocation; applying a quasi-random or random azimuth rotation to each of the plurality of query images, and storing the azimuth rotation for each of the plurality of rotated query images; training a machine learning model, including: extracting features from the plurality of rotated query images; estimating the azimuth rotation of the rotated query image based on an inference of the extracted features of the rotated query image and extracted features from the candidate images, and using an objective function including a first loss function based on a weighted soft-margin triplet loss, and a second loss function based on an absolute angle error between the stored azimuth rotation and the estimated azimuth rotation for the stored dataset.

### TECHNICAL FIELD

The invention relates generally to the field of machine learning. One aspect of the invention relates to a computer implemented method for training a machine learning model. Another aspect of the invention relates to a server using a machine learning model in inference phase. A further aspect of the invention relates to a computer implemented method for inference using a machine learning model. A still further aspect of the invention relates to a mobile communication device using a machine learning model in inference phase.

### BACKGROUND

Photos not only contain memories, but also provide us a way to learn and perceive the world through others' eyes, to find details that one may have overlooked earlier, and to share emotions and knowledge with the community. With advances in hardware, personal high-quality cameras have become much more affordable. Many creators are keen on sharing photos on the internet. The captured images may not be as carefully calibrated as if they were taken by a dedicated multi-sensor system (e.g., Google Street-View vehicles), but the sheer volume of crowdsourced images may provide rich information. If we can efficiently estimate the missing meta information (e.g., geo-location, camera orientation) of those images and calibrate them for “ready-to-use” status, this enormous hidden treasure can help on various downstream tasks, e.g., map information extraction, car navigation and tracking, UAV positioning, hazard detection, social studies.

To accomplish this goal, we may carry out three or more tasks: (a) adjust the image upright, (b) find the location, and/or (c) estimate the viewing angle of the camera.

Image-based geo-localization is a line of study aiming at inferring the camera location of street-view images. Among various geo-localization approaches, cross-view geo-localization uses geo referenced aerial images (mostly satellite imagery). Given a street-view query image (FIG. 1(a)), the system finds the most similar match in a pool of satellite images (FIG. 1(b)), and then takes the satellite image centre as the localization result. Thanks to its image retrieval nature, cross-view matching with satellite imagery can be applied in large-scale searches with promising results.

For example, a paper entitled “Where Am I Looking At? Joint Location and Orientation Estimation by Cross-View Matching,” Y. Shi, X. Yu, D. Campbell and H. Li, in 2020 IEEE/CVF Conference on Computer Vision and Pattern Recognition (CVPR), Seattle, WA, USA, 2020 pp. 4064-4072, the contents of which are incorporated herein by reference, discloses a methodology to estimate the orientation of a query image (such as a street-view image) relative to a candidate image (such as satellite image). This document will be referred to herein as the “DSM” paper.

One technical problem that may exist in the art is how to improve the accuracy of the orientation estimate of the query image, the geographic location of the query image, and/or match accuracy of any points of interest or other features within the query image.

### SUMMARY

Embodiments may be implemented as set out in the independent claims. Some optional features are defined in the dependent claims.

Implementation of the techniques disclosed herein may provide significant technical advantages. Advantages of one or more aspects may include:
Significant improvement in the accuracy of orientation estimation.
Improvement of the ground truth definition and/or the coordinate system.
Defining an absolute angle error and an angle loss as a proportion of the absolute angle error to the maximum.
Using angle loss as part of the objective function during training of the model.
Define a south-aligned orientation alignment coordinate and a continuous absolute angle error coordinate for orientation estimation in cross-view matching with satellite imagery.
FOV invariant due to south-aligned orientation alignment coordinate and angle error coordinate system.
Propose two methods to enhance the granularity of orientation estimation of street-view images without introducing any additional learnable parameters.
Propose a set of metrics for orientation estimation, which is easier to understand and gives better clarity for real-world use-cases.
Significant improvement in the accuracy of geo-localization.

In an exemplary implementation, the functionality of the techniques disclosed herein may be implemented in software running on a server communication apparatus (such as a cluster of servers or a cloud computing platform), which communicates with the applications running on the terminals, such as mobile phones. The software which implements the functionality of the techniques disclosed herein may be contained in a computer program, or computer program product. The server communication apparatus establishes secure communication channels with the user terminals for receiving the queries from users and rendering the search ranking results to the users. The process may also include the training of a machine learning model, using the model in inference phase, and/or identifying points of interest with an estimated location and orientation.

### BRIEF DESCRIPTION OF THE DRAWINGS

The invention will now be described, by way of example only, and with reference to the accompanying drawings in which:

FIG. 1(a) are Street-view image queries with 0° and 315° clockwise misalignments.

FIG. 1(b) is a Geo-referenced satellite imagery as the reference for cross-view matching.

FIG. 1(c) is a Visualization of angle misalignment on a sample street-view image.

FIG. 2 is a schematic block diagram illustrating an exemplary delivery/transportation service.

FIG. 3 is a schematic block diagram illustrating an exemplary communications server for the delivery/transportation service.

FIG. 4(a) is a schematic diagram of Camera axes.

FIG. 4(b) is a Geo-referenced satellite imagery of South-aligned reference coordinate for orientation shift.

FIG. 4(c) is a Visualization of rotation applied on images to create orientation misalignment.

FIG. 5a is a schematic block diagram of an overall architecture for geo-localization and orientation estimation. Example shows with 360° FOV.

FIG. 5b is a schematic block diagram of an Inference architecture for geo-localization and orientation estimation.

FIG. 6 is a Histogram of angle errors for the best instance of each model on 360° image test. Each set has 8,884 images.

FIG. 7 is a Histogram of the difference between matched cases and all cases for CVACT same/across dataset tests. Most of the removed results are with good orientation estimation.

FIG. 8 is a Histogram of angle errors for CVUSA and CVACT on same dataset tests (last 10 degrees).

FIG. 9 is a Histogram of angle errors for CVUSA and CVACT on across dataset tests (first 10 degrees).

FIG. 10 is a Histogram of angle errors for CVUSA and CVACT on across dataset tests (last 10 degrees).

### DETAILED DESCRIPTION

The techniques described herein are described primarily with reference to use in cross view matching of street-view images with satellite images. This might be useful in map creation, augmented reality, navigation, etc.

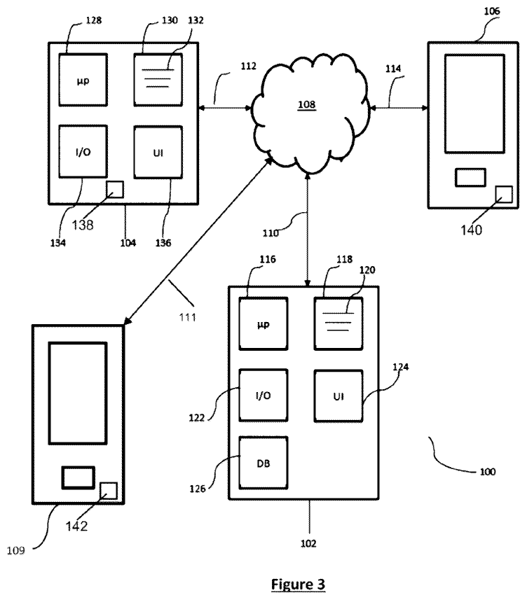

FIG. 2 shows an exemplary architecture of a system 100, with a number of users each having a communications device 104, a number of merchants each having a communication device 109, a number of drivers each having a user interface communications device 106, a server 102 (or geographically distributed servers) and communication links 108 connecting each of the components. Each user contacts the server 102 using a user software application (app) on the communications device 104. Similarly the drivers and merchants may use an app on their devices 106, 109.

For deliveries or e-commerce based transactions, the user device 104 may allow the users to input queries containing the keywords for the items of interest and delivery addresses. The user may see a list of merchants and/or items provided by the merchants, and order items from the merchants. The merchant may contact the server 102 using the merchant device 109 for providing the information about their items and receiving orders for each confirmed transaction. The drivers contact the server 102 using the driver device 106. The driver device 106 allows the drivers to indicate their availability to take the delivery jobs, information about their vehicle, their location. The server 102 may then match drivers to the delivery, based on, for example: geographic location of merchants and drivers, maximising revenue, user or driver feedback ratings, weather, driving conditions, traffic level/accidents, relative demand, environmental impact, and/or supply levels. The user may be offered a particular delivery cost and approximate delivery ETA. If the user accepts the offer, the system may go through a payment authorisation process. If the authorisation is approved, the merchant will then be notified and directed to provide goods for the driver to pickup. The selected driver will then be notified and directed to the pickup location to pickup the goods. During the delivery both the user device 104, the driver's device 106, the merchant's device 109 and the server 102 may be updated with real-time trip information including real-time location of the driver's vehicle, the destination, the driver fare and/or other trip related information. At the conclusion of the trip the driver's device 106 may send a confirmation the trip has ended to the server 102. Once the transaction is approved and/or the delivery completed the user device 104, the driver's device 106, the merchant's device 109 and the server 102 may be updated with details of the completed financial transaction. This allows an efficient allocation of resources because the available fleet of drivers is optimised for the users' demand in each geographic zone.

For transportation, the user device 104 may allow the user to enter their pick-up location, a destination address, one or more service parameters, and/or after-ride information such as a rating. The one or more service parameters may include the number of seats of the vehicle, the style of vehicle, level of environmental impact and/or what kind of transport service is desired. Each driver contacts the server 102 using a driver app on the communication device 106. The driver app allows the driver to indicate their availability to take the ride jobs, information about their vehicle, their location, and/or after-ride info such as a rating. The server 102 may then match users to drivers, based on, for example: geographic location of users and drivers, maximising revenue, user or driver feedback ratings, weather, driving conditions, traffic level/accidents, relative demand, environmental impact, and/or supply levels. The user may be offered a particular transport cost or a range based on different types of vehicles, and an approximate ETA. If the user accepts the offer, the system may go through a payment authorisation process. If the authorisation is approved, the selected driver will then be notified and directed to the pickup location to pickup the user/passenger. During the trip both the user device 104, the driver's device 106, the merchant's device 109 and the server 102 may be updated with real-time trip information including real-time location of the driver's vehicle, the destination, the trip fare and/or other trip related information. At the conclusion of the trip the driver's device 106 may send a confirmation the trip has ended to the server 102. Once the transaction is approved and/or trip completed the user device 104, the driver's device 106, the merchant's device 109 and the server 102 may be updated with details of the completed financial transaction. This allows an efficient allocation of resources because the available fleet of drivers is optimised for the users' demand in each geographic zone.

Referring to FIG. 3, further details of the components in the system of FIG. 2 are now described. The communication apparatus 100 comprises the communication server 102, and it may include the user communication device 104, the merchant communication device 109 and the driver communication device 106. These devices are connected in the communication network 108 (for example, the Internet) through respective communication links 110, 111, 112, 114 implementing, for example, internet communication protocols. The communication devices 104, 106 and 109 may be able to communicate through communication networks and/or protocols, including cellular communication networks, LAN, WAN, private data networks, VPN, fibre optic connections, laser communication, microwave communication, satellite communication, Bluetooth, Wifi, NFC, etc., but these are not specified in FIG. 3 for the sake of clarity.

The communication server apparatus 102 may be a single server as illustrated schematically in FIG. 3. Alternatively, the functionality performed by the server apparatus 102 may be distributed across multiple physically or logically separate server components. In the example shown in FIG. 3, the communication server apparatus 102 may comprise a number of individual components including, but not limited to, one or more microprocessors 116, a memory 118 (e.g. a volatile memory such as a RAM, and/or longer term storage such as SSD (Solid State or Hard disk drives (HDD)) for the loading of executable instructions 120, the executable instructions defining the functionality the server apparatus 102 carries out under control of the microprocessor 116. The communication server apparatus 102 also comprises an input/output module 122 allowing the server to communicate over the communication network 108. User interface 124 is provided for administrator control and may comprise, for example, computing peripheral devices such as display monitors, computer keyboards and the like.

The server apparatus 102 may also comprise a database 126 stored in memory 118, for storing data, which may include data on geographic information, images, products, points of interest, users, drivers, merchants, transactions and other relevant data. The data may be stored in a data structure according to the requirements of the application, or as described in more detail below. The database 126 may be replicated, distributed, sharded or otherwise optimised according to the requirements of the application, or as described in more detail below.

The user communication device 104 may comprise a number of individual components including, but not limited to, one or more microprocessors 128, a memory 130 (e.g., a volatile memory such as a RAM), and/or longer term storage such as flash memory or SSD (Solid State drives) for the loading of executable instructions 132, the executable instructions defining the functionality the user communication device 104 carries out under control of the microprocessor 128. The user communication device 104 also comprises an input/output module 134 allowing the user communication device 104 to communicate over the communication network 108. A user interface 136 is provided for user control. If the user communication device 104 is, say, a smartphone or tablet device, the user interface 136 will have a touch panel display as is prevalent in many smartphones and other handheld devices. Alternatively, if the user communication device 104 is, say, a desktop or laptop computer, the user interface 136 may have, for example, computing peripheral devices such as display monitors, computer keyboards and the like.

The merchant communication device 109 may be, for example, a smartphone or tablet device with the same or a similar hardware architecture to that of the user communication device 104.

The driver communication device 106 may be, for example, a smartphone or tablet device with the same or a similar hardware architecture to that of the user communication device 104. Alternatively, the functionality may be integrated into a bespoke device such as a taxi fleet management terminal.

It may be useful as part of a delivery, e-commerce, ride hailing, map, street-view or enterprise mapping solutions to provide accurate cross view matching of professionally sourced street-view imagery, crowdsourced photos, and images of Points of Interest to satellite imagery in a meaningful fashion. While Google street-view does have adequate street-view imagery for some locations, it may be out of date or not provided at all in some more remote locations. For example, in South East Asia there are many locations which do not have street-view images.

For example, each of the user communication device 104, driver communication device 106, and/or the merchant communication device 109 may include a camera. In the case of the user communication device 104, the camera 138 may be integrated as part of the smartphone or tablet device. In the case of the driver communication device 106, the camera 140 may be mounted on the driver's vehicle, or on the driver's person, such as on a helmet. In the case of the merchant communication device 109, the camera 142 may be integrated as part of the smartphone or tablet device. The user communication device 104, driver communication device 106, and/or the merchant communication device 109, may be singly or collectively known as the mobile communication device(s).

The cameras 138, 140, 142 can be used to collect street-view images suitable for query images in a training dataset for a machine learning model. The cameras may capture 360° geotagged still images, or they may capture reduced field of view (FOV). They may include an azimuth angle estimate (relative to a south heading). Alternatively, camera 140, for example may include a number of cameras mounted together, each having a limited FOV and different azimuth axis, and the images from each are stitched together to form a 360° geotagged still image. The images may be captured on a periodic basis, e.g.: every 1 second, they may be captured at prespecified GPS coordinates, or they may be capture depending on the vehicle movement e.g.: every 5 meters of travel. This process may be automated, or a user may capture images of specific points of interest and annotate them at the time.

The geotagging may be in the form of estimated longitude and latitude, from an onboard GPS module in the respective mobile communication device(s). This may include an estimated compass bearing relative to the camera's axis.

The cameras 138, 140, 142 can be used to collect street-view images suitable for query images during inference using a machine learning model.

It may therefore be desirable to provide a robust cross view matching machine learning model that could be used in South East Asia or in other locations where Google street-view is out of date or non-existent.

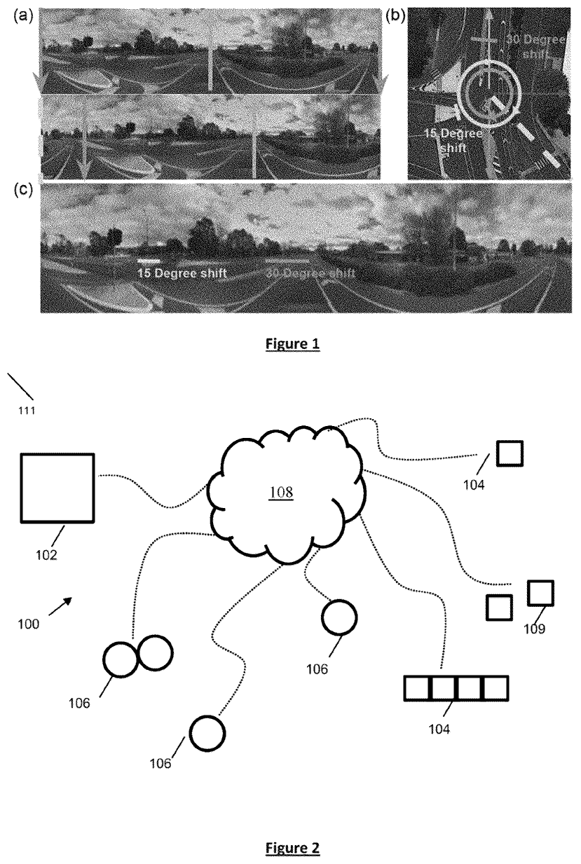

Apart from accurately estimating the geo-location of street-view images, the present inventors have attempted to estimate the fine-grained camera orientation of street-view images for three reasons:
1) With the accurate camera orientation, information extracted from street-view images, especially from using single-image algorithms (e.g., depth estimation, object detection), enables a wider range of real-world applications, e.g., map creation, augmented reality, navigation. In practice, even a very small misalignment in orientation can propagate a large shift to the physical position of objects detected in images. For example, FIG. 1 (c) shows that an orientation error of 15° is large enough to mislocate an exit to another lane; an error of 30° is sufficient to mistakenly assign attributes to the reverse direction of the road.
2) Nowadays, crowdsourced high-quality 360° or wide-angle images can be taken by semi-professional 360° cameras or even by phones. These images are usually not carefully calibrated. It is more likely that the orientation information is missing but a rough location is labelled, rather than vice versa. Hence, the problem of finding the location of street-view images assuming the orientation is known is no longer realistic.
3) Based on our experiments, we observe that by introducing a finer granularity to orientation estimation, the performance of geo-localization can be further improved. We hypothesize that finding fine-grained orientation could also potentially improve the performance of geo-localization of crowdsourced images.

Thus, it will be appreciated that FIGS. 2, 3 and 5b and the foregoing description illustrate and describe a system comprising:
a communication server 102;
at least one mobile communication device 104, 106, 109; and
communication network equipment 108 configured to establish communication with the communications server 102, and the at least one mobile communication device 104, 106, 109;
wherein the mobile communication device 104, 106, 109 comprises a first processor and a first memory, the mobile communications device 104, 106, 109 being configured, under control of the first processor, to execute first instructions stored in the first memory to:
capture a query image;
transmit the query image to the communication server 102;
and wherein the communication server 102 comprises a second processor and a second memory, the communication server 102 being configured, under control of the second processor, to execute second instructions stored in the second memory to:
operate in an inference phase, using a machine learning model trained based on a weighted soft-margin triplet loss function and an absolute angle error loss function, to estimate the azimuth rotation and/or geolocation of the query image.

Further, it will be appreciated that FIG. 5a illustrates and describes a method performed in a communication server apparatus 102, the method comprising, under control of a microprocessor 116 of the server apparatus 102:
storing a training dataset including a plurality of geotagged candidate images and a plurality of query images, each query image having at least one corresponding candidate image having the same geolocation;
applying a quasi-random or random azimuth rotation to each of the plurality of query images, and storing the azimuth rotation for each of the plurality of rotated query images;
training a machine learning model, including:
   extracting features from the plurality of rotated query images;
   estimating the azimuth rotation of the rotated query image based on an inference of the extracted features of the rotated query image and extracted features from the candidate images, and
   using an objective function including a first loss function based on a weighted soft-margin triplet loss, and a second loss function based on an absolute angle error between the stored azimuth rotation and the estimated azimuth rotation for the stored dataset.

A particular approach to selecting a machine learning model, selecting a dataset, training the model using a dataset, validating the model, testing the model, and using the model for inference, may be adapted by a person skilled in the art according to the requirements of a desired application. An example implementation will be given below.

### Coordinate Systems

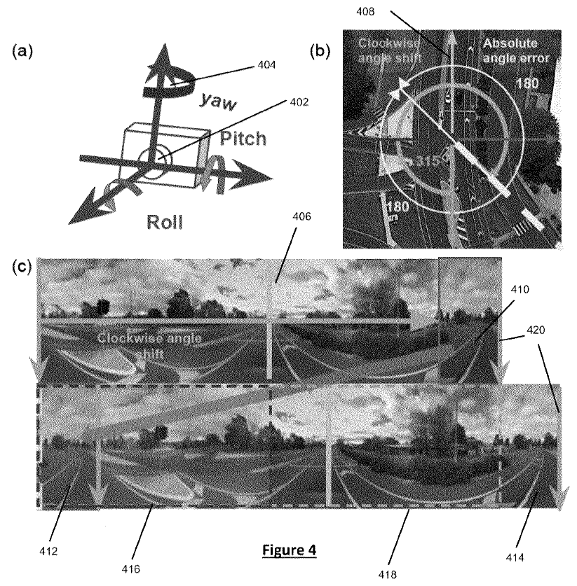

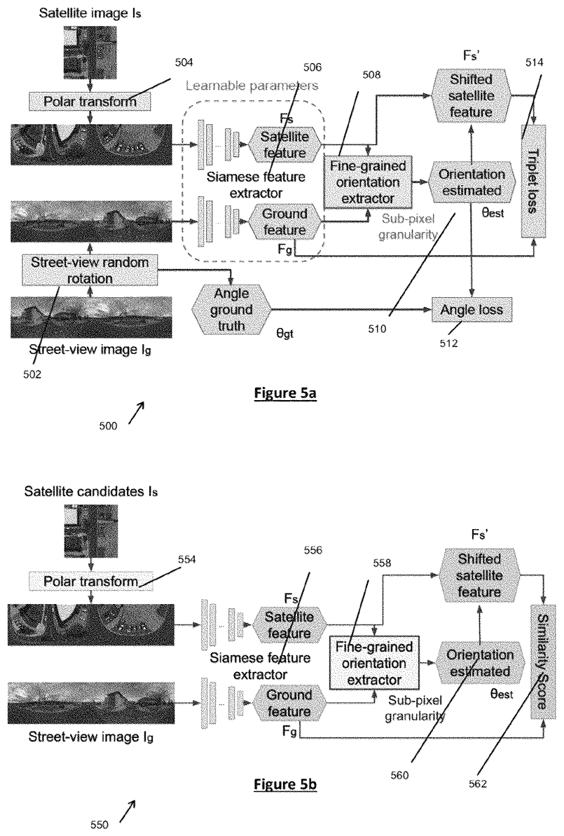

Besides geo-localization, finding accurate camera orientation camera orientation is the other critical task to prepare street-view images for “ready-to use” status. FIG. 4 (a) shows the three camera angles 402 required for calibration. The pitch and roll angle along with other camera distortion can be corrected to provide upright corrected images. After such corrections, the street-view images are upright and only the yaw angle, “azimuth rotation” 404, or the orientation, is required to be estimated. In some training datasets, the orientation of the street-view image is north-aligned, which means the centre column of the image points to the Geographic North Pole (marked by the arrow 406 in FIG. 4 (c) top) to ensure it is aligned with the north direction of the geo-referenced satellite imagery (north marked by the arrow 408 in FIG. 4 (b)).

Geo-localization may obtain better performance if the orientations of the street-view images are known. The prior art may have a different definition of the orientation misalignment and error.

Given an upright street-view image I_{g} (FIG. 4 (c) top) or “query image” and a set of geo-referenced satellite imagery (FIG. 4 (b)) “candidate images”, a system shall identify the satellite image Iₛ at the same location as I_{g} from a pool of satellite image candidates. The centre location of Iₛ is assigned to be the location of I_{g}.

Given a set of upright street-view images I_{g}={I_{g}} and a set of geo-referenced satellite images Iₛ={Iₛ}, which are paired and cropped at the same location of their paired street-view image, an orientation misalignment θ_{gt} (“quasi random or random azimuth rotation”) is created for each street-view and satellite pair. For each street-view query image I_{g}, the similarity and orientation θₑₛₜ between the query I_{g} and every satellite image candidate in Is are estimated. The satellite candidates are ranked by their similarity. The centre location of the top-1 satellite image and the estimated orientation with the correct match are extracted as the estimated location and orientation of the query image I_{g}. We may aim to reduce the error between the estimated orientation θₑₛₜ and θ_{gt}, while maintaining or improving the recall of geo-localization.

### Machine Learning Model

Our model is trained with unknown orientation or “quasi random or random azimuth rotations” (even though the actual orientation is stored for use in the loss function, as explained later). Specific details of the machine learning model are provided in exemplary embodiments below.

### Dataset

The training, verification and testing dataset may be selected according to the requirements of the application.

The training dataset may contain two types of imagery, street-view imagery upright corrected and orthorectified aerial imagery. This may be captured using a structured process by cameras 138, 140, and/or 142, or existing datasets may be used, where appropriate for the application.

After the structure process of image acquisition the street-view imagery should desirably include one or more of the following qualifications:
After pre-processing the imagery is upright corrected, which means only the azimuth angle are not calibrated (in FIG. 4 (a) the yaw angle is the azimuth angle).
The imagery can have a full field of view (FOV), such as a 360° image or a limited FOV (less than 360 degrees).
The imagery can be single image taken by phone, standard camera or an image stitched by multiple images.
The imagery may have small angle uncertainty in roll and pitch direction (FIG. 4 (a))

The aerial imagery may be extracted from existing satellite imagery libraries or acquired through structured acquisition. After pre-processing the aerial imagery should desirably include one or more of the following qualifications:
The aerial imagery is orthorectified and geo-referenced.
The imagery can be taken by different platform, satellite, aircraft, UAV, etc.
The imagery shall have high resolution e.g.: imagery ground sampling distance (GSD) below 1 meter/pixel.
The aerial imagery can be cropped imagery chips with a standard size from a larger aerial image tiles.

In order for there to be supervised training using the dataset, some pre-existing relationship between the street-view imagery and the aerial imagery must exist. For the ground truth pairing:
For every query street-view image, its location can be covered by one or multiple matched aerial images.
In the case of creating one-to-one pairing, every query street-view image has one positive matched aerial imagery.
In the case of creating one-to-many pairing, every query street-view image may have multiple positive matched aerial imagery. However, among all matched aerial images, there shall be a scoring system/rank to indicate the best to poorest matching. For example, this can be calculated by the distance between the query image location and the centre location of the aerial images.
It is also possible an aerial image does not match to any query street-view images.
For the cropping of aerial imagery, there are two ways to prepare the dataset:
   The aerial imagery are cropped around the location of the street-view images.
   The aerial imagery are cropped uniformly with/without overlapping between image chips across an area of interest, e.g. a city, a state.

Location of street-view imagery can be used as the addition information to create the dataset or in the evaluation.

For example, existing datasets, include CVUSA and CVACT. Both datasets contain 35,532 training street-satellite matched pairs and 8,884 test pairs. All images are angle-aligned. At the training time, random shifting and cropping (if with limited FOV) are applied to street-view images. In testing, we followed the orientation shift given to each matched pair. Note that the two datasets are collected in the US and Australia separately and have a non-negligible domain shift. CVUSA contains a mix of commercial, residential, suburban, and rural areas and CVACT leans towards urban/suburban styles. Additionally, the satellite images in CVUSA have a higher ground coverage but a lower resolution than CVACT, which introduces another substantial domain shift.

Note that the two datasets are collected in the US and Australia separately and have a non-negligible domain shift. CVUSA contains a mix of commercial, residential, suburban, and rural areas and CVACT leans towards urban/suburban styles. Moreover, the satellite images in CVUSA have a higher ground coverage but a lower resolution than CVACT, introducing another substantial domain shift.

### Training Method

The training method may be selected according to the requirements of a particular application.

For example a training method 500 is shown in FIG. 5(a). It includes random azimuth rotations to the street-view images 502, polar transforming the satellite images 504, feature extraction 506, fine grained orientation extraction 508, orientation estimation 510, angle loss based on the absolute angle error 512, and triplet loss function 514.

The training method may be implemented using server 102 in FIGS. 2 and 3.

### Pre-Processing

Before passing the input images to the feature extractors, the following pre-processes are applied to street-view images and satellite images respectively:
In training, street-view images are randomly rotated to introduce orientation misalignments 502. The ground truth shift in feature space w_{gt} is recorded to calculate the angle loss and orientation estimation accuracy, where θ_{gt}=w_{gt}/width(Fs)*360° and Fs is the extracted feature from satellite images.
Satellite images are polar-transformed 504 to a similar viewing point and size as the street-view images to physically reduce the gap between street-view and satellite view images. FIG. 5a left top shows the effect of polar transformation.
All street-view images and polar-transformed satellite images are resized to [128, 512] pixels in height and width. [128, 512] is for polar transformed satellite images and 360 street-view images. For street-view images with limited FOV, a width reduction is proportional to the FOV. e.g. 180° images are resized to [128,256]. The output of this step shall be proportional to the FOV.

To create the misalignment between the street-view image and geo-referenced satellite image, we randomly shift the street-view images clockwise and record this angle shift θ_{gt} in a south-aligned reference coordinate. FIG. 4(c) shows an example of shifting the street-view image 315° clockwise. Semantically, the augmentation crops the right-most part 410 outside the shifting angle and stitches it to the left-most column 412 of the street-view image, and then crops 414 the field of view (FOV) required for the output. In FIG. 4 (c), box 416 shows FOV of 180°, box 418 shows FOV of 360°. Although the original image pairs are north-aligned, we choose the south alignment as the reference, namely the alignment between the first column of the image to the south direction of the satellite image (marked in arrows 420 in FIG. 4). This change is made for images with limited FOV. After cropping, the centre column is shifted left-wards and is no longer aligned with the angle shift ground truth θ_{gt}. For example, in a north-aligned coordinate, if a 360° image is shifted by 90 degrees clockwise and cropped to FOV of 180°, the angle shift between the centre column and the north direction becomes 45 degrees; if cropped to 120°, the angle shift becomes 30 degrees.

Table 1 shows different methods for creating misalignment. Compared to the DSM paper, our method is FOV invariant, θ_{gt} is consistent regardless of the FOV. Compared to Sijie Zhu, Taojiannan Yang, and Chen Chen. 2021. Revisiting street-to-aerial view image geo-localization and orientation estimation. In Proceedings of the IEEE/CVF Winter Conference on Applications of Computer Vision. 756-765, rotating street-view image is easier to implement, and our method avoids losing the corners of satellite images because of rotation and distortions caused by interpolation.

TABLE 1
Different methods to rotate and create misalignment.

| Methods | Rotation on | Alignment | FOV invariant |
|---|---|---|---|
| DSM [36] | Street-view | North | |
| Zhu et al. [61] | Satellite | South | ✓ |
| Ours | Street-view | South | ✓ |

We propose to calculate the absolute angle error between the estimated angle shift θₑₛₜ and ground truth angle shift θ_{gt}. Centred to the θ_{gt}, the errors count up to 180 degrees to the opposite direction (FIG. 4 (b)). The absolute angle error coordinate may have the following advantages:
Avoid a sudden change of 360 degrees around the border case in 360° clockwise system (0↔360) and [−180, 180] system (−180↔180). Our absolute error coordinate is continuous everywhere, being more natural for defining the angle loss function
More fair to compute angle errors. For example, when the ground truth θ_{gt}=0° and two estimations are θₑₛₜ₁=170° and θₑₛₜ₂=240°. In a 360° system, the angle error for θₑₛₜ₁ is 170° and for θₑₛₜ₂ is 240°, so θₑₛₜ₁ shall be favoured even though θₑₛₜ₂ is closer to θ_{gt} with an absolute error of 120°. Our system shall favour θₑₛₜ₂ instead of θₑₛₜ₁.
Easy to calculate angle error from two angles shifts given in the south-aligned coordinate. Given θ1 and θ2 in south-aligned coordinate, their angle difference can be calculated as:

$${θ}_{diff} = 180 ° \vert - \vert \vert {θ}_{1} - {θ}_{2} \vert - 180 ° \vert . \qquad ( 1 )$$

For an unknown orientation, images can be randomly rotated up to 360°. The rotation unit is about 0.70°, corresponding to the shift in one pixel of the input image. For example, 360 degrees in the above example divided by 512 pixels=0.7°.

The algorithm 3 shows the augmentation to rotate the street-view images and create orientation shift ground truth in feature space. It allows sub-pixel locations of the ground truth for fine-grained orientation estimation.

Algorithm 3: Shift and crop Street-view Image

Input: Street-view image I, feature map width w, field of view γ.
Output: Shifted image I_{sc}, ground truth alignment w_{gt}.
w_{f} = γ/360 * w //calculate the cropped image width
x_{shift} = randint(0, I.width − 1) //define a random shift
/* shift image */
Iₛ = concat(I[I.width − x_{shift} :], I[: I.width − x_{shift}])
I_{sc} = Iₛ [: w_{f}] // cropped the first w_{f} pixels
w_{gt} = mod(((I.width − x_{shift})/I.width * w), w) //shift in feature
map width
return I_{sc}, w_{gt}

We use polar transformation to pre-process the satellite images. Given a satellite image with the size of (Sₛ,Sₛ), to transform it into a flattened image with the size as street-view image (H_{g},W_{g}), the pixel relation between satellite coordinate

$${s}_{i}^{s} , {y}_{i}^{s}$$

and street-view coordinate

$${x}_{i}^{g} , {y}_{i}^{g}$$

(both coordinate take the left-upper corner as the origin):

$${x}_{i}^{s} = \frac{{S}_{s}}{2} - \frac{{S}_{s}}{2} \frac{{H}_{g} - {y}_{i}^{g}}{{H}_{g}} sin ( \frac{2 π}{{W}_{g}} {x}_{i}^{g} )$$

$${y}_{i}^{s} = \frac{{S}_{s}}{2} + \frac{{S}_{s}}{2} \frac{{H}_{g} - {y}_{i}^{g}}{{H}_{g}} cos ( \frac{2 π}{{W}_{g}} {x}_{i}^{g} )$$

### Feature Extraction

The pre-processed satellite and street-view images are sent to Siamese feature extractors 506, which are VGG16. The extractors consist of the first 10 layers of VGG16 and 3 additional convolutional layers to further compress the feature maps on the vertical axis. The last three layers have an output feature depth of [256, 64, 16] and stride [(2, 1), (2, 1), (1, 1)] in the vertical and horizontal axes. For full 360° inputs with size [128, 512, 3], two feature maps Fs and Fg with a size of [4, 64, 16] in [H, W, C] are extracted respectively. The two branches have the same architecture without weight sharing.

### Fine-Grained Orientation Estimation

The extracted features Fs and Fg are processed by the fine-grained orientation extractor 508 to infer 510 the sub-pixel level angle shift θₑₛₜ.

To find fine-grained orientation (at a sub-degree level) 508, we propose two methods to increase the granularity of the estimation without increasing the number of learnable parameters.

After obtaining the features Fs and Fg, the cross-correlation is calculated as:

$$( {F}_{g} ⋆ {F}_{s} ) [ w ] = {\sum }_{m = 1}^{{W}_{g}} {F}_{g} [ m ] {F}_{s} [ {( m + w )}_{mod {W}_{s}} ] , \qquad ( 2 )$$

where Fg/s [m] is a slice of features at horizontal position m across all height and channels. Ws and Wg are the width of Fs and Fg. The position with the highest cross-correlation value is taken as the estimated angle shift wₑₛₜ in the feature space to estimate the orientation 508.

As our input images have a width of 512 pixels, the shifting unit is about 0.7 degree (360°/512 pixels). However, Fs and the cross-correlation result (Equation 2) only has a width of 64 pixels (the satellite image has the same width, but the extracted feature has shorter width, it is compressed by the model), which makes the orientation extractor have a maximum resolving power of 5.625 degree (360°/64 pixels). It might be desirable for some applications to increase the resolution. To refine the granularity of the estimation, we proposed two approaches.

Algorithm 1: Feature Interpolation (FI)

| Input: street-view features F_{g}, satellite features Fₛ, scaling factor S. | |
|---|---|
| Output: Estimated orientation in feature space wₑₛₜ | |
| ${F}_{g}^{s} = interpolate ( {F}_{g} , S ) ,$ | ${F}_{s}^{s} = interpolate ( {F}_{s} , S )$ |
| $( {F}_{g}^{s} {★F}_{s}^{s} ) [ w ] = cross - corr ( {F}_{g}^{s} , {F}_{s}^{s} ) // eqn ( 2 )$ | |
| ${w}^{s} = {max}_{position} ( ( {F}_{g}^{s} ⋆ {F}_{s}^{s} ) [ w ] ) // find shift with max value$ | |
| wₑₛₜ = w^{s}/S | // get sub-pixel position |

return wₑₛₜ

Algorithm 2: Curve Smoothing (CS)

Input: street-view features F_{g}, satellite features Fₛ, scaling factor S.
Output: Estimated orientation in feature space wₑₛₜ
(F_{g} ★ Fₛ)[w] = cross-corr(F_{g}, Fₛ) // coarse curve
((F_{g} ★ Fₛ)[w])_{fft-padded} = zero-padding(FFT((F_{g} ★ Fₛ)[w]),S)
((F_{g} ★ Fₛ)[w])ₛₘₒₒₜₕ = IFFT(((F_{g} ★ Fₛ)[w])_{fft-padded})
w^{s} = maxₚₒₛᵢₜᵢₒₙ(((F_{g} ★ Fₛ)[w])ₛₘₒₒₜₕ)
wₑₛₜ = w^{s} /S // sub-pixel position
return wₑₛₜ

Feature interpolation (FI): Following algorithm 1, both Fs and Fg are interpolated with a scaling factor S before calculating the fine-grained cross-correlation curve. In our implementation, we increase the granularity by 10 times. The bin number with the maximum cross-correlation curve is extracted and is divided by S to obtain sub-pixel level estimation west. The resolving power of the model is refined to 0.5625 degree (360°/640 pixels).

Curve smoothing (CS): Following algorithm 2, the cross-correlation curve (Fg★Fs) [w] is calculated with the original resolution (64 bins). To smooth the curve with scaling factor S=10, the coarse cross-correlation curve is transformed to frequency domain with Fast Fourier Transform (FFT) and zero-padded of (S−1) times to the middle of the curve:

$$ZP ( F [ w ] , S ) = Concat ( F [ 0 : int ( W / 2 ) ] , zeros [ 0 : ( S - 1 ) W ] , F [ int ( W / 2 ) + 1 : ] ) ,$$

where W is the width of the F [w]. The output of zero-padding is again converted back by Inverse FFT (IFFT). The fine-grained orientation extractor with CS has a resolving power of 0.5625 degree.

Both CS and FI provide the flexibility to adjust the granularity of the orientation extraction via the changeable scaling factor. For example, if the street-view image does not have full FOV it may be more difficult to find the correct result. So, in this case, maybe the user wants to reduce the difficulty of the task by using a smaller scaling factor.

### Objective Function

With the estimated orientation, the satellite features Fs can be azimuth shifted (to match the estimated orientation) and cropped (F′s) to be aligned with the street-view features Fg in orientation and FOV. The output features F′s and Fg are used to calculate the triplet loss. Moreover, an angle loss is used to provide direct supervision on the orientation estimation.

To have direct supervision on angle estimation, we propose an angle loss based on the absolute angle error 512. Given the ground truth orientation in feature space w_{gt}, the estimated orientation wₑₛₜ and the width of the feature map space W, the angle loss is given as:

$${L}_{angle} = ( 0.5 W - \vert \vert {w}_{gt} - {w}_{est} \vert - 0.5 W \vert ) / 0.5 W , \qquad ( 3 )$$

which is equivalent to the rate of the angle error to the maximum error of 180°. Note that this loss is only applied to matched pairs.

For the geo-localization task, we utilize a weighted soft-margin triplet loss 514. Given a triplet consists of an anchor query image A in one view, the positive sample P (correct match) and a negative sample N in the other view, the feature (FA) extracted from A shall have a smaller distance to the shifted and cropped feature (F′P) from the P than the shifted and cropped feature (F′N) from N. We take the cosine distance between features in our implementation. The loss function is given as:

$${L}_{match} = ln ( 1 + exp ( α ( D ( {F}_{A} , {F}_{P}^{′} ) - D ( {F}_{A} , {F}_{N}^{′} ) ) ) ) \qquad ( 4 )$$

$$D ( {F}_{1} , {F}_{2} \} = 2 ( 1 - cos ( {F}_{1} , {F}_{2} ) ) ,$$

where the α=10. For a batch size of B, each query can form (B−1) triplets. In each matching direction (street→satellite or satellite→street), B(B−1) triplets are constructed. We enforce the matching on both directions and have totally 2B(B−1) triplets in each mini-batch. The overall objective function is:

$$L = {L}_{match} ( A , P , N ) + β {L}_{angle} ( A , P ) . \qquad ( 5 )$$

The loss function weight for angle loss may be set as β=0.3. However, depending on the application, the weight for angle loss may be varied between 0.1-0.5.

### Implementation Details

Our models are trained with unknown orientation. The first 10 layers of the VGG16 based feature extractors use the pre-trained weights on ImageNet and the last three layers are initialized randomly. Note that in our model all parameters are learnable. Batch size B is set to 32. We use an Adam optimizer with an initial learning rate of between 5 to 15, or for example 11e-5, learning rate decrease on plateau is applied with factor 0.5, patience 8. The maximum training time is set to 200 epochs and the early stopping threshold is 30 epochs. The models are trained with 4 NVIDIA Tesla V100 GPU.

### Inference Method

FIG. 5b is an example of the Inference Phase. The query images might be crowdsourced street-view images, 360° or limited FOV.

The inference method may be selected according to the requirements of a particular application.

The dataset for inference may include, for example, a set of satellite images for a given geographic territory. This may allow query street-view images within that territory to be submitted for inference. Once the query images have an estimated orientation and/or geolocation they can be incorporated into the dataset for later use.

For example, an inference method 550 is shown in FIG. 5(b). It includes polar transforming the satellite images 554 (as detailed above during training), feature extraction 556, fine grained orientation extraction 558 (either FI or CS as detailed above during training), orientation estimation 560, and ranking by similarity score 562. The similarity score may use cos(Fs, Fg).

The inference method 550 may be implemented using server 102 and mobile device 104, 106, 109 in FIGS. 2 and 3. The mobile device 104, 106, 109 may be used to transmit query images. The dataset set including satellite images, query images (with orientation and/or geolocation estimates), and/or and extracted and located POIs, can be stored in memory 118, or database 126 for later use in the desired application such as navigation, VR/AR, 3D map visualizations etc.

During inference, if the orientation between satellite and street-view is known (θ_{gt}=0), the orientation extractor is not used, only cropping of Fs to have the same FOV is applied; if the orientation is unknown, the fine-grained orientation extractor finds the alignment. Shifting and cropping of Fs are applied. Given a query street-view image, the feature similarities between the query and all possible satellite candidates are calculated along with the orientation estimation.

POI Extraction from Street-View Images

Given a street-view image with no location/coarse location and orientation information, firstly the location and orientation are estimated by cross-view matching with the satellite image candidates in the ROI (Region of interest). The region of interest can be: Large ROI—anywhere in the world; city ROI—specific city or districts; local ROI—selected streets/neighbourhood; point ROI—around an area within 100+ meters. The location and orientation of the highest similarity ranking image are used as the result.

Secondly based on the extracted geolocation and orientation, the street-view image is rotated to the correct orientation and give it a 2D location on the map. For human viewing applications, would be an interactive system for current users' viewpoints. For downstream applications, only the orientation angle to the south of the input image is stored.

Thirdly the points or objects of interest (building, sign, etc) are extracted from the rotated street-view image, and estimate the objects' location in the image coordinates.

Fourthly the information of the object from the image coordinate system is transferred to the world system based on the geolocation and orientation of the image. The downstream application, such as object detection, could extract the object segmentation (where it is in the image) and get the relative location of the object to the camera centre. Then when we know the orientation and the location of the image so we can translate the extracted information to the world frame. The extraction and translation can be part of the functionality of the downstream tasks.

Fifthly the information of the objects are placed on the map. The information can include what the object is, a cropped image of the object, location of the object, etc.

In an alternative scenario, given a street-view image with accurate location but with no orientation information, firstly the orientation is estimated by matching with the satellite image candidates cropped at the given location. Satellite images usually come as image tiles. Usually, each tile covers a large area, possibly a few sqkm. Each tile can be cropped down to smaller satellite chips as the input to the feature extractor.

Secondly based on the location and extracted orientation, the street-view image is rotated and give it a 2D location on the map.

Thirdly the objects of interest (building, sign, etc) are extracted from the rotated street-view image, and estimate the objects' location in the image coordinates.

Fourthly the information of the object is transferred from the image coordinate system to the world system based on the geolocation and orientation of the image.

Fifthly the information of the objects is placed on the map.

With the object's information on the map, it can be used for navigation viewing, or information viewing.

Alternatively, these steps can include human verification steps instead of taking the top 1 result. The human annotator can choose the best result from a set of top results from the ML model.

### Experimental Results

A histogram H(θ) at 1° granularity is calculated for the absolute angle errors. For every image in the test set, given the ground truth θ_{gt} and the estimation θₑₛₜ:

$${θ}_{err} = 180 ° - \vert \vert {θ}_{g t} - {θ}_{e s t} \vert - 180 ° \vert , \qquad ( 6 )$$

$$H ( {θ}_{i} ) = H ( {θ}_{i} ) + 1 , where {θ}_{i} - 1 \leq {θ}_{err} < {θ}_{i} .$$

With the fine-grained histogram, 1-to-1 visual comparison between models and the accumulated accuracy curve at any specific degree can be retrieved easily. It shows the distribution and reliability of the orientation estimation, which are crucial for downstream tasks.

The mean of angle errors of all test images is calculated to evaluate the orientation performance independently on geo-localization for two reasons: 1) There exist alternative sources to obtain location-tag, e.g., social media, and the orientation estimation remains to be the bottleneck for downstream tasks. Any missing orientation information gives the testing images a 180° uncertainty. 2) A 180° error may not affect the geo-localization result, but could be the worse case for many downstream tasks, e.g., navigation. Hence, the mean is used to calculate the error linearly for the entire test set.

The accuracy of test images with an estimation error below a specific threshold is calculated. For a given fine-grained histogram H(θ) (Equation 6), the rate below x° is given as:

$$r @ x ° = {{\sum }^{x}}_{i = 1} H ( {θ}_{i} ) / {{\sum }^{180}}_{i = 1} H ( {θ}_{i} ) . \qquad ( 7 )$$

With these metrics, the users can decide whether the estimated orientation fits the downstream tasks, which usually come with a tolerance of orientation errors.

Table 2 shows the performance of our models on orientation estimation on 360° images. As only a few works report their results on orientation estimation and use different metrics, we conduct a full comparison using the newly proposed metrics.

The prior art (labelled as DSM [36]*) is used as the baseline to calculate the improvement shown in the bracket. Both our models, FI and CS, show significant improvement in the mean error, r@2° and r@5° for all test cases.

TABLE 2
Orientation estimation on two datasets.

| | Mean | r@2° | r@5° | Mean | r@2° | r@5° |
|---|---|---|---|---|---|---|
| | error ↓ | (%) | (%) | error ↓ | (%) | (%) |
| Model | CVUSA | | | CVACT | | |
| Zhai [56] | — | ≤15 | — | — | — | — |
| Zhu [61] | — | ≤24 | — | — | — | — |
| DSM [36]* | 5.29° | 47.49 | 93.25 | 6.26° | 44.13 | 88.31 |
| Ours (FI) | 3.78° | 82.13 | 96.77 | 4.88° | 70.87 | 92.29 |
| Gain | (1.51°) | (34.64) | (3.52) | (1.38°) | (26.74) | (3.98) |
| Ours (CS) | 3.77° | 82.42 | 96.75 | 4.75° | 72.28 | 92.43 |
| Gain | (1.52°) | (34.93) | (3.50) | (1.51°) | (28.15) | (4.12) |

Both datasets have a similar mean error improvement of about 1.38° to 1.52° from their original mean error of 5.29° and 6.26°. However, CVUSA observed higher absolute improvement on r@2° (about 35%) than CVACT (about 28%). Comparing the histogram visualized in FIG. 6, the error distribution of CVUSA is further pushed to the lower angle error region than the distribution of the CVACT results. Around 57% of the test dataset of CVUSA obtained an orientation estimation with an error below 1° which is around 45% for CVACT. For CVACT, some test cases that are not pushed below the 2° error region are still successfully reduced within 5°. We hypothesize that the CVUSA dataset contains a larger portion of suburban, rural areas than CVACT, which leads the images in CVUSA naturally to have less obvious features, such as buildings, to leverage. This makes the precise orientation estimation has more influence on CVUSA than CVACT.

Between FI and CS, FI interpolates the coarse feature maps with a large scaling number to generate a fine-grained correlation curve with new values, while CS obtains sub-pixel correlation curve values by smoothing the original curve. From our experiment results in Table 2, CS obtains slightly better results than FI on orientation extraction. However, FI gives a more fundamental fine-grained orientation curve generation. It could be useful when prior knowledge of the rough orientation is available, which can be added to the street-view features before the orientation curve is generated.

### Geo-Localization

Finding fine-grained orientation does not only provide additional orientation information but also improves the performance of geo-localization. We evaluate the geo-localization result of our models in known/unknown orientation tests. The r@1 of CVUSA and CVACT are shown in Table 3. Note that the performance of the best instance of our FI, CS and the prior art are reported to have a fair comparison. Compared to the prior art (labelled as DSM [36]*), r@1 for known/unknown orientation test on CVUSA improved by 1.93%, 4.70% for FI and 1.80%, 4.64% for CS; on CVACT are improved by 2.91%, 5.17% for FI and 2.34%, 5.55% for CS. Additional results on across dataset and mixed dataset tests and visualization of the top 5 best matched and worst mismatched cases are shown in the supplementary materials.

We achieved better r@1 than all existing methods; especially on CVACT obtaining absolute improvement of 1.66% and 2.66% on known and unknown orientation test, without implementing additional sampling strategy or computational expensive architecture.

TABLE 3
Evaluation on geo-localization for the two datasets.

| | known | unknown | known | unknown |
|---|---|---|---|---|
| | r@1 (%) | r@1 (%) | r@1 (%) | r@1 (%) |
| Model | CVUSA | | CVACT | |
| CVM-NET [17] | 22.47 | — | 20.15 | — |
| Liu & Li [25] | 40.79 | — | 46.96 | — |
| CVFT [38] | 61.43 | — | 61.05 | — |
| SAFA [35] | 89.84 | — | 81.03 | — |
| LPN-SABA [48] | 92.83 | — | 83.66 | — |
| DSM [36]* | 93.57 | 80.75 | 83.88 | 75.24 |
| L2LTR [52] | 94.05 | — | 84.89 | — |
| GAN-SAFA [42] | 92.56 | — | 83.28 | — |
| SSANET [57] | 91.52 | — | 84.23 | — |
| SEH VGG16 | 94.46 | — | — | — |
| bs 30 [16] | | | | |
| SEH VGG16 | 95.11 | 85.36 | 84.75 | 78.13 |
| bs 120 [16] | | | | |
| SEH FCANet18 | 95.04 | 85.37 | 85.13 | 77.41 |
| bs 120 [16] | | | | |
| TransGeo [60] | 94.08 | — | 84.95 | — |
| Ours (FI) | 95.50 | 85.45 | 86.79 | 80.41 |
| Ours (CS) | 95.37 | 85.39 | 86.22 | 80.79 |

### Ablation Study

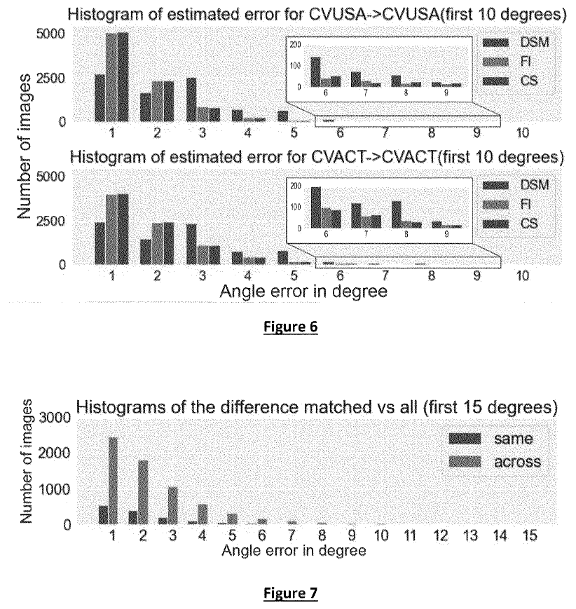

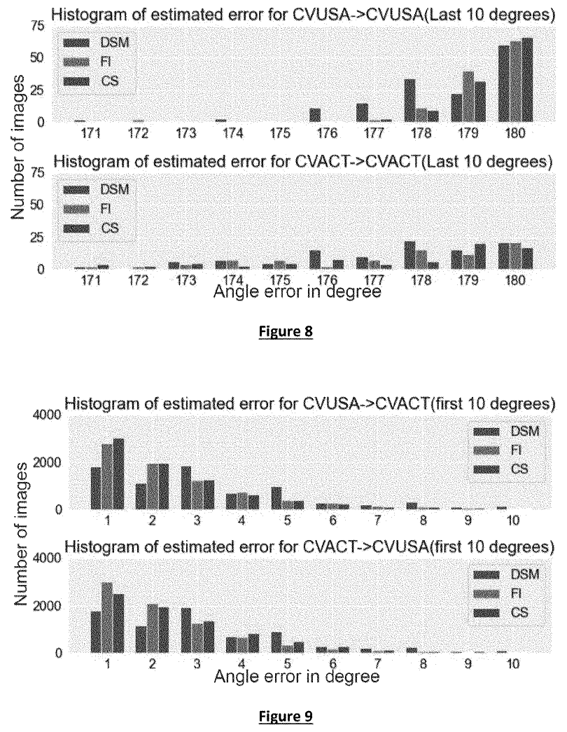

In Table 4, the best instance of FI CVACT and CS CVUSA is shown, ‘all’ means the results of all test images; ‘matched’ means the results of only the matched images; ‘matched to all’ means the results of the matched cases divided by the number of images of the full test set (8,884 images). After removing across dataset tests. The r@2° also increases for all tests. Both indicate the images with good geo-localization results have a better orientation estimation in general. However, if consider orientation estimation as an individual problem, any missing estimation given the test images a 180° uncertainty, filtering results based on the location correctness can end up having a very low percentage of correctly estimated images in the full dataset. For across dataset tests, r@2° (matched to all) drops to 9.02% and 12.69%, although the models have the ability to give high-quality orientation to 57.09% and 55.94% of the full test images. FIG. 7 shows the majority of the removed cases obtain a high to medium quality orientation estimation. Mislocated images are not necessarily having low-quality orientation estimation. Additionally, evaluating only on location-matched images can lead to an unfair comparison, e.g., a model can trick the evaluation by having only one correctly located image with a perfect estimated orientation. Hence, we believe the evaluation of orientation estimation can be independent of geo-localization, unless it is for specific use cases.

TABLE 4
Orientation estimation evaluated on all
test data or location matched data.

| | CVACT-> | CVUSA-> | CVACT-> | CVUSA-> |
|---|---|---|---|---|
| | CVACT | CVUSA | CVUSA | CVACT |
| unknown r@1 | 80.41% | 85.39% | 12.84% | 19.43% |
| mean error (all) | 4.79° | 3.65° | 18.28° | 13.00° |
| mean error (matched) | 1.85° | 1.96° | 2.98° | 2.27° |
| r@2 (all) | 72.60% | 83.87% | 57.09% | 55.94% |
| r@2 (matched) | 77.03% | 86.15% | 70.20% | 65.30% |
| r@2 (matched to all) | 61.94% | 73.56% | 9.02% | 12.69% |

### Limited FOV

We test on images with 180° (fish-eye camera) and 90° (wide-angle camera). The first test uses models trained on 360° images to simulate the situation when a model is trained on well collected 360° images, but the test images are crowdsourced with limited FOV. Table 5 shows the average performances of FI models on CVACT. The absolute improvements to the prior art (labelled as DSM [36]*) are given in the brackets. For geo-localization unknown r@1, our result has a 9.60% and 6.83% improvement for 180° and 90° tests. For the orientation estimation, we observe improvement on all metrics compared to the prior art.

TABLE 5
Performance of models trained on 360° CVACT
images and tested on 180°, 90°.

| FOV | r@1 (%) | Mean error ⬇ | r@2° (%) | r@5° (%) |
|---|---|---|---|---|
| 180° | 56.47 (9.60) | 9.48° (2.79°) | 51.12 (19.56) | 81.85 (8.91) |
| 90° | 21.88 (6.83) | 21.57° (3.62°) | 30.90 (10.92) | 55.35 (6.64) |

Secondly, we test on FI models trained with limited FOV to understand whether images with limited FOV still contain enough information for learning fine-grained orientation estimation. Table 6 present the results of models trained on 180° and 90°. Compared to the prior art (labelled as DSM [36]*), our model FI gives improvement in most of the metrics, indicating our methods is applicable for limited FOV. The improvement to prior art and performance itself on 180° is much more significant than 90° This reduction caused by decreased FOV is more drastic in models trained with limited FOV compared to what we observed in full FOV trained models (Table 5). Additionally, besides the unknown r@1 of 180° obtains a higher performance than the model trained with 360°

TABLE 6
CVACT model trained and tested on limited FOV.

| FOV | Model | r@1 (%) | Mean error ↓ | r@2° (%) | r@5° (%) |
|---|---|---|---|---|---|
| 180° | DSM [36]* | 58.11% | 12.31° | 25.41% | 64.13% |
| | Ours FI | 67.07% | 10.26° | 34.82% | 69.61% |
| 90° | DSM 36]* | 16.77% | 39.50° | 8.22% | 23.61% |
| | Ours FI | 21.08% | 40.42° | 9.01% | 21.23% |

Our methods improve the orientation estimation performance for both datasets. It has a higher influence on CVUSA, as images in CVUSA have less complex scenes and obvious features. In general, CS obtains slightly better results in our test cases, however, FI gives more fundamental fine-grained orientation curve generation, this could be useful when prior knowledge of the rough orientation is available. Geo-localization: by integrating fine-grained orientation estimation, the trained models obtain higher performance, compared to baseline models. The r@1 for both datasets achieve better scores than existing methods. Evaluation: When the street-view images are correctly geo-localized, the orientation estimation has higher precision. However, most of the location-incorrect images still obtain high to medium quality orientation estimation. It is also fairer to evaluate orientation estimation independently from geo-localization. Limited FOV: Our models also obtained relative improvement compared to the prior art models.

### Histograms for Same/Across Dataset Tests

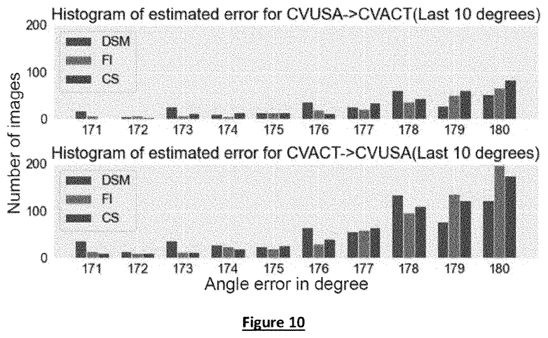

FIG. 6, FIG. 8, FIG. 9 and FIG. 10 shows the histograms of the best models of the prior art system (labelled as DSM [36]*), compared to our system, labelled as FI and CS for same dataset test (last 10°) and across dataset test (first and last 10°).

### Performance on Across Dataset Tests

For across dataset tests, we train on one dataset and test on the other dataset. For example, in Table 7 and Table 8 CVACT→CVUSA means model trained on CVACT train set and tested on CVUSA test set.

TABLE 7
Orientation extraction results in across dataset tests.

| | Mean | r@2° | r@5° | Mean | r@2° | r@5° |
|---|---|---|---|---|---|---|
| | error ↓ | (%) | (%) | error | (%) | (%) |
| Model | CVUSA−>CVACT | | | CVACT−>CVUSA | | |
| DSM [36]* | 15.48° | 32.45 | 72.18 | 22.21° | 32.40 | 72.04 |
| Ours (FI) | 13.15° | 52.94 | 79.77 | 19.13° | 54.95 | 81.21 |
| Gain | (2.33°) | (20.49) | (7.59) | (3.08°) | (22.55) | (9.17) |
| Ours (CS) | 13.02° | 54.30 | 80.21 | 18.61° | 54.13 | 81.73 |
| Gain | (2.46°) | (21.85) | (8.03) | (3.60°) | (21.73) | (9.69) |

TABLE 8
Geo-localization results in across dataset tests.

| | known | unknown | known | unknown |
|---|---|---|---|---|
| | r@1 (%) | r@1 (%) | r@1 (%) | r@1 (%) |
| Model | CVUSA->CVACT | | CVACT->CVUSA | |
| SAFA [35] | 30.40 | — | 21.45 | — |
| DSM [36]* | 38.47 | 18.42 | 21.68 | 8.01 |
| L2LTR [52] | 47.55 | — | 33.00 | — |
| Ours (FI) | 43.58 | 20.85 | 30.29 | 12.84 |
| Ours (CS) | 42.04 | 19.43 | 29.06 | 12.47 |

The performance on orientation extraction is shown in Table 7. Because of the domain shift between the two datasets, both test cases have larger mean errors to begin with, compared to same dataset tests. The r@2° have an absolute improvement around 20% to 23% from the original accuracy about 32% for both cases. CVACT→CVUSA obtained better improvements on the mean error (about 3.6°) and r@5° (about 9.7%). Combining the fact that CVACT has a worse initial mean error for across dataset tests, we believe the higher ratio of urban images in CVACT leads the models to leverage the obvious features, e.g., buildings. When such features are missing in the CVUSA, it results in a worse performance than the reversed case (CVUSA→CVACT). By integrating fine-grained orientation estimation in training, the models improve on generalization and transferability and have less dependency on easy features.

For geo-localization, by learning ne-grained orientation estimation, the trained models gain higher generalization and transferability in across dataset tests without implementing additional sampling strategy or computational expensive architecture. Compared to our implementation of the prior art (labelled as DSM [36]*), the r@1 for known/unknown orientation for CVUSA→CVACT are improved by 5.11%, 2.43% for FI and 3.57%, 1.01% for CS; for CVACT→CVUSA are improved by 8.61%, 4.83% for FI and 7.38%, 4.46% for CS. Hongji Yang, Xiufan Lu, and Yingying Zhu. 2021. Cross-view Geo-localization with Layer-to-Layer Transformer. Advances in Neural Information Processing Systems 34 (2021), “L2LTR” achieves higher performance on known orientation tests, with the usage of ResNet backbone with 12 layers of vision transformers on each view to bridge the gap between two views. However, L2LTR is not able to solve the orientation uncertainty and can only be applied to orientation known imagery. This makes it not suitable for extracting both orientation and location information to preparing the street-view imagery into ready-to-use status.

### Performance on Mixed Dataset Tests

Table 9 and Table 10 show the performance of best instance of each model trained on CVACT in a test that the test set of the two datasets are mixed. Besides the metrics used in the main sessions, few new metrics are added to understand the improvements in the sets and their contribution to the overall performance. For r@1, r@2° r@5° and mean error, we show the breakdown for same dataset (data in CVACT test set) and across dataset (data in CVUSA test set). Additionally, a hit rate within its own dataset is calculated, which shows the percentage of queries of each dataset choose a satellite candidate from its own satellite pool.

TABLE 9
Orientation extraction performance of mixed
dataset tests on model trained on CVACT.

| | Ours FI | DSM [36]* | Gain |
|---|---|---|---|
| r@2° | 64.85% | 38.70% | 26.15% |
| r@2° (same) | 72.60% | 44.26% | 28.34% |
| r@2° (across) | 57.10% | 33.15% | 23.95% |
| r@5° | 87.45% | 80.60% | 6.85% |
| r@5° (same) | 92.54% | 88.44% | 4.10% |
| r@5° (across) | 82.36% | 72.76% | 9.60% |
| Mean error ⬇ | 11.53° | 14.22° | 2.69° |
| Mean error (same) ↓ | 4.79° | 6.30° | 1.51° |
| Mean error (across) ↓ | 18.28° | 22.14° | 3.86° |

TABLE 10
Geo-localization performance of mixed dataset
tests on model trained on CVACT.

| | Ours FI | DSM [36]* | Gain |
|---|---|---|---|
| unknown r@1 | 46.21% | 40.99% | 5.22% |
| unknown r@1 (same) | 79.90% | 74.56% | 5.34% |
| unknown r@1 (across) | 12.53% | 7.42% | 5.11% |
| unknown hit (same) | 97.57% | 97.13% | 0.44% |
| unknown hit (across) | 95.42% | 88.65% | 6.76% |
| known r@1 | 58.05% | 51.96% | 6.09% |
| known r@1 (same) | 86.37% | 83.35% | 3.02% |
| known r@1 (across) | 29.73% | 20.57% | 9.16% |
| known hit (same) | 98.20% | 97.87% | 0.33% |
| known hit (across) | 96.69% | 91.69% | 5.00% |

Compared to the prior art: (1) our FI model not only improves the performance of the same test dataset, but also propagates the improvement to across test dataset.

For r@5° mean error, known r@1 and all hit rates, the gains in the across test set are even higher than the same test set. (2) The hit rate for unknown and known orientation tests both obtain more balanced performances and reduce the gap between the same and across test datasets. Our model gives less unfair favours to the training dataset. Both of the results show that learning orientation extraction improves not only the performance of the trained models, but also improves the generalization of the models to be applied in other geo-location/slightly different acquisition settings.

### Large Location Offset Test

We consider the matched pairs in CVUSA and CVACT are perfectly location aligned. However, the datasets do contain small location translation offsets due to GPS errors, the camera location shall be on the main road instead of the side road, the top 1 prediction is actually closer to the real position. For some extreme cases, the camera locations of the street-view images are their matched satellite images. The actual camera location drifts of from the matched image (ground truth) and actually is around the top 1 prediction given by our model. Hence, our models tolerate small location offsets.

TABLE 11
Model performance on VIGOR dataset with our CS methods.

| | S10 known | S1 unknown | S10 unknown |
|---|---|---|---|
| known r@1 | 16.99% | 20.81% | 20.81% |
| known hit rate | 22.86% | 28.60% | 28.56% |
| unknown r@1 | 11.47% | 16.67% | 16.70% |
| unknown hit rate | 16.34% | 24.54% | 24.46% |
| Mean error ↓ | 36.46° | 34.53° | 34.51° |
| r@2° | 10.54% | 9.80% | 11.52% |
| r@5° | 24.21% | 27.23% | 26.43% |

We also tested on the VIGOR dataset (camera locations have large offsets to the satellite image centres). The result is shown in Table 11. Large offsets indeed reduce the overall performance. But we found adding fine-grained orientation extraction still improves the performance:
Training with unknown orientation increases performance on r@1, r@2°, r@5° and mean orientation error, compared to models trained with known orientation.
Training with a high scaling factor of fine-grained orientation improves the fine-grained orientation extraction, compared to models trained with a lower scaling factor.
   Performance of Geo-Localization and Orientation on Two Datasets with Different Configurations.

Table 12 shows the performance with different configurations. The average performance of three instances of angle weight is reported.

TABLE 12
Performance of geo-localization and orientation on two datasets with different configurations.

| | | CVACT −>CVACT | | | | | CVACT−>CVUSA | | | | |
|---|---|---|---|---|---|---|---|---|---|---|---|
| | angle | known | unknown | Mean | | | known | unknown | Mean | | |
| | weight | [symbol] | [symbol] | error(°)↓ | r@2° | r@5° | [symbol] | [symbol] | error(°)↓ | r@2° | r@5° |
| DSM [ [symbol] ] [symbol] | — | 8 [symbol] % | 75.14% | [symbol] .26 | 4 [symbol] % | 88. [symbol] 1% | 21.69% | 7.90% | 22.21 | 32.40% | [symbol] % |
| DSM (all) | — | [symbol] 6 [symbol] 6% | 80.0 [symbol] % | [symbol] .67 | 46.07% | 89.91% | [symbol] % | 11.00% | 20. [symbol] | 35.05% | 75 [symbol] % |
| DSM (all) + AL | 0.1 | 86.12% | 80.19% | [symbol] | 43.80% | 88.66% | [symbol] % | 11.28% | 20. [symbol] | 35.22% | 76.28% |
| DSM (all) + AL | 0.3 | 86.15% | 80.04% | 5.56 | 45.25% | 8 [symbol] .42% | [symbol] % | 11.0 [symbol] % | 20.57 | 35.12% | [symbol] % |
| DSM (all) + AL | 0.5 | 86.17% | 80.14% | 5. [symbol] | 44.08% | 88 [symbol] % | 2 [symbol] .52% | 11.00% | 20. [symbol] 6 | 32.7 [symbol] % | [symbol] % |
| DSM (all) + FI | — | 8 [symbol] .5 [symbol] % | 80.53% | 4.82 | 7 [symbol] 2% | 92.24% | 27.27% | 11.23% | 19.5 [symbol] | [symbol] % | 80 [symbol] % |
| DSM (all) + AL + FI | 0.1 | [symbol] % | 80. [symbol] % | 4.89 | 69 [symbol] % | [symbol] % | 27.70% | 11.41% | 1 [symbol] | [symbol] % | 81 [symbol] % |
| DSM (all) + AL + FI | 0.3 | 86.59% | 80. [symbol] % | 4.88 | 70.87% | 92. [symbol] % | 29 [symbol] % | 12.08% | 1 [symbol] 3 | [symbol] % | [symbol] % |
| DSM (all) + AL + FI | 0.5 | 86.4 [symbol] % | 80. [symbol] % | 4. [symbol] | 70.4 [symbol] % | 92. [symbol] % | 28.14% | 12.0 [symbol] % | 1 [symbol] | 55.58% | [symbol] % |
| DSM (all) + CS | — | 86. [symbol] 7% | 80. [symbol] % | 4.79 | 7 [symbol] % | 92.39% | 27.2 [symbol] % | 11. [symbol] % | 19.17 | 54.0 [symbol] % | [symbol] % |
| DSM (all) + AL + CS | 0.1 | 8 [symbol] .18% | 80.19% | 4.8 [symbol] | 71.16% | 92.32% | 26.86% | 11.49% | 20.05 | [symbol] % | 79.21% |
| DSM (all) + AL + CS | 0.3 | 86.29% | 80.23% | 4.75 | 72.28% | 92.4 [symbol] % | 28.45% | 11.7 [symbol] % | [symbol] | [symbol] % | 81.73% |
| DSM (all) + AL + CS | 0.5 | 86.38% | 80.17% | 4.81 | 70.81% | 9 [symbol] .41% | 26.73% | 10. [symbol] % | 19.82 | [symbol] % | 81.07% |
| | | CVUSA −>CVUSA | | | | | CVUSA −>CVACT | | | | |
| DSM [ [symbol] ] [symbol] | — | 93.29% | 80.54% | 5.29 | 47.49% | 93.25% | 3 [symbol] % | 18.43% | 15.48 | 32.45% | 72.18% |
| DSM (all) | — | 94.9 [symbol] % | 84.30% | 4.53 | 50.76% | [symbol] % | 41. [symbol] % | 20. [symbol] 3% | 13.90 | [symbol] % | [symbol] % |
| DSM (all) + AL | 0.1 | [symbol] 75% | 84. [symbol] 7% | 4.75 | 4 [symbol] .39% | [symbol] % | 3 [symbol] .03% | 1 [symbol] .32% | 1 [symbol] .82 | [symbol] 8% | [symbol] % |
| DSM (all) + AL | 0.3 | 94.90% | 84.76% | 4.76 | 47.20% | [symbol] % | 41.15% | [symbol] 0.32% | 1 [symbol] .99 | [symbol] .17% | 74.01% |
| DSM (all) + AL | 0.5 | 94.82% | 84. [symbol] 7% | [symbol] .03 | 4 [symbol] .14% | 93.05% | 40. [symbol] % | 19.50% | 13.50 | 33.70% | [symbol] % |
| DSM (all) + FI | — | 95.30% | 84.91% | 3.77 | [symbol] .04% | 96.71% | 41.58% | 19. [symbol] % | 13.34 | 52.20% | [symbol] % |
| DSM (all) + AL + FI | 0.1 | 95.32% | 85.2 [symbol] % | 3.85 | 81.21% | 96. [symbol] % | 42.97% | 20. [symbol] % | 12.93 | 52.62% | [symbol] % |
| DSM (all) + AL + FI | 0.3 | 95.29% | 8 [symbol] .98% | 3.7 [symbol] | [symbol] % | 96.77% | 41.9 [symbol] % | 2 [symbol] % | 13.15 | 5 [symbol] % | 79.77% |
| DSM (all) + AL + FI | 0.5 | 95.35% | 85.28% | [symbol] | 82.15% | 9 [symbol] .76% | 42.02% | 20.01% | 1 [symbol] .30 | 52.17% | [symbol] % |
| DSM (all) + CS | — | 95.32% | 84. [symbol] % | 3.73 | 81. [symbol] % | 9 [symbol] .7 [symbol] % | [symbol] % | 20.59% | 12.77 | [symbol] % | 80.14% |
| DSM (all) + AL + CS | 0.1 | [symbol] % | 84.93% | 3.74 | [symbol] 2.20% | 96. [symbol] % | 42.78% | 20. [symbol] 4% | 12.92 | 52.36% | 79. [symbol] % |
| DSM (all) + AL + CS | 0.3 | 95 [symbol] % | 85.19% | 3.77 | 82.42% | 96.75% | 42. [symbol] % | 20.00% | 1 [symbol] .02 | 54 [symbol] % | 80.21% |
| DSM (all) + AL + CS | 0.5 | 95.29% | 85.24% | 3.84 | [symbol] % | 9 [symbol] % | 42.40% | 2 [symbol] .24% | 12. [symbol] | 52.30% | [symbol] % |

[symbol]

indicates data missing or illegible when filed

What is claimed is:

1. A computer assisted method comprising:
storing a training dataset including a plurality of geotagged candidate images and a plurality of query images, each query image having at least one corresponding candidate image having the same geolocation;
applying a quasi-random or random azimuth rotation to each of the plurality of query images, and storing the azimuth rotation for each of the plurality of rotated query images;
training a machine learning model, including:
extracting features from the plurality of rotated query images;
estimating the azimuth rotation of the rotated query image based on an inference of the extracted features of the rotated query image and extracted features from the candidate images, and
using an objective function including a first loss function based on a weighted soft-margin triplet loss, and a second loss function based on an error loss between the stored azimuth rotation and the estimated azimuth rotation for the stored dataset.

2. The method of claim 1 further comprises cropping each of the plurality of rotated query images to a restricted field of view.

3. The method of claim 1 wherein the training a machine learning model further comprising ranking the correlation of the extracted features of the plurality of candidate images to the extracted features of the rotated query image, selecting the highest ranked candidate image, and estimating the geolocation of the query image by the geolocation of the highest ranked candidate image.

4. The method of claim 3 wherein the training a machine learning model further comprising adjusting the orientation of the plurality of candidate images based on the estimated azimuth rotation of the query image and/or cropping the field of view of the plurality of candidate images depending on the field of view of the query image.

5. The method of claim 3 further comprising storing an approximate geolocation for one or more of the plurality of query images, and selecting a subset of the candidate images based on proximity to the approximate geolocation of the query image to correlate against the query image.

6. The method of claim 1 wherein the objective function is defined as
$$L = {L}_{match} ( A , P , N ) + β {L}_{a n g l e} ( A , P ) , .$$

7. The method of claim 6 wherein the first loss function is defined as
$${L}_{m a t c h} = ln ( 1 + exp ( α ( D ( {F}_{A} , {F}_{P}^{′} ) - D ( {F}_{A} , {F}_{N}^{′} ) ) ) )$$
$$D ( {F}_{1} , {F}_{2} ) = 2 ( 1 - cos ( {F}_{1} , {F}_{2} ) ) .$$

8. The method of claim 6 wherein the second loss function is defined as
$${L}_{angle} = ( 0.5 W - \vert {w}_{g t} - {w}_{e s t} \vert - 0.5 W ) / 0.5 W .$$

9. The method of claim 8 wherein the error loss is determined using an absolute angle error.

10. The method of claim 9 wherein the absolute angle error is calculated using θerr=180°−∥θgt θest|−180°|.

11. The method of claim 6 wherein β is between 0.1 to 0.5 or is substantially similar to 0.3.

12. The method of claim 1 further comprising applying one or more metrics to the machine learning model selected from the group consisting of a fine-grained histogram, a mean angle error, an accuracy below specific threshold and any combination thereof.

13. The method of claim 12 wherein the fine-grained histogram is calculated using
$${θ}_{err} = 180 ° - \vert \vert {θ}_{g t} - {θ}_{e s t} \vert - 180 ° \vert ,$$
$$H ( {θ}_{i} ) = H ( {θ}_{i} ) + 1 , where {θ}_{i} - 1 \leq {θ}_{err} < {θ}_{i} .$$

14. The method of claim 12 wherein the accuracy below specific threshold fine is calculated using
$$r @ x ° = {{\sum }^{x}}_{i = 1} H ( {θ}_{i} ) / {{\sum }^{180}}_{i = 1} H ( {θ}_{i} ) .$$

15. The method of claim 1 further comprising applying a polar transform to each of the plurality of candidate images.

16. The method of claim 1 wherein the applying a random azimuth rotation comprises cropping a portion of one side of the image and appending it to the other side of the image.

17. The method of claim 1 wherein the training dataset is based on a south aligned coordinate system, the plurality of query images corresponding to street-view images and the plurality of candidate images corresponding to aerial images.

18. The method of claim 1 wherein the training a machine learning model further comprising interpolating the extracted features of the rotated query image and extracted features from the candidate images by a scaling factor, and correlating the interpolated extracted features of the rotated query image and the interpolated extracted features from the plurality of candidate images using the first loss function.

19. The method of claim 1 wherein the training a machine learning model further comprising correlating the interpolated extracted features of the rotated query image and the interpolated extracted features from the plurality of candidate images using the first loss function, and smoothing a curve associated with the correlation using a scaling factor.

20. The method of claim 19 wherein the smoothing the curve comprises:
Fast Fourier Transforming (FFT) the correlation curve to the frequency domain;
zero-padding of predetermined number of times to the middle of the transformed curve; and
Inverse Fast Fourier Transforming (FFT) the zero padded curve.

21. A method comprising using a trained machine learning model in an inference phase, wherein the machine learning model was trained using the method of claim 1.

22. A system comprising
a communication server;
at least one mobile communication device; and
communication network equipment configured to establish communication with the communications server, and the at least one mobile communication device;
wherein the mobile communication device comprises a first processor and a first memory, the mobile communications device being configured, under control of the first processor, to execute first instructions stored in the first memory to:
capture a query image;
transmit the query image to the communication server;
and wherein the communication server comprises a second processor and a second memory, the communication server being configured, under control of the second processor, to execute second instructions stored in the second memory to:
operate in an inference phase, using a machine learning model trained according to claim 1, to estimate the azimuth rotation and/or geolocation of the query image.

23. A mobile communication device according to the at least one mobile communication device in claim 22.

24. A computer assisted method using a machine learning model for orientation estimation and/or geolocation estimation, including:
extracting features from a query image;
interpolating the extracted features of the query image and extracted features from a plurality of candidate images by a scaling factor;
estimating the azimuth rotation of the interpolated query image based on an inference of the extracted features of the interpolated query image and extracted features from the plurality of interpolated candidate images;
shifting the plurality of interpolated candidate images based on the estimated azimuth rotation;
determining a similarity score between the interpolated query image and the plurality of interpolated candidate images; and
inferring the geolocation of the query image based on the similarity score.

25. A computer assisted method using a machine learning model for orientation estimation and/or geolocation estimation, including:
extracting features from a query image;
estimating the azimuth rotation of the query image based on an inference of the extracted features of the query image and extracted features from a plurality of candidate images;
shifting the interpolated candidate images based on the estimated azimuth rotation;
correlating the extracted features of the query image and the extracted features from the plurality of shifted candidate images;
smoothing a curve associated with the correlation; and
inferring the geolocation of the query image based on the smoothed correlation curve using a scaling factor.

26. The method of claim 25 wherein the smoothing the curve comprises:
Fast Fourier Transforming (FFT) the correlation curve to the frequency domain;
zero-padding of a predetermined number of times to the middle of the transformed curve; and
Inverse Fast Fourier Transforming (FFT) the zero padded curve.

27. The method of claim 24 further comprising a user selecting the scaling factor.
